(19) United States
(12) Patent Application Publication
(10) Pub. No.: US 2023/0038800 A1
(43) Pub. Date: Feb. 9, 2023

(54) STATE DETECTION SENSOR

(71) Applicant: DENSO CORPORATION, Kariya-city (JP)

(72) Inventors: Tomohiro IMURA, Kariya-city (JP); Norio GOKO, Kariya-city (JP); Toshihisa TANIGUCHI, Kariya-city (JP); Keiji OKAMOTO, Kariya-city (JP)

(21) Appl. No.: 17/878,945

(22) Filed: Aug. 2, 2022

(30) Foreign Application Priority Data
Aug. 4, 2021 (JP) 2021-128436

(51) Int. Cl. G01K 3/04; G01K 7/04; G01K 7/02

(52) U.S. Cl. CPC G01K 3/04; G01K 7/04; G01K 7/021

(57) ABSTRACT

A state detection sensor is provided with a first sensor unit, a second sensor unit, an intermediate insulation sensor disposed between the first sensor unit and the second sensor unit. The first surface of the intermediate insulation layer is joined to the second wiring of the first sensor unit. The second surface of the intermediate insulation layer is joined to the third wiring of the second sensor unit. The first sensor unit and the second sensor unit are electrically connected in series in a state where a polarity of thermoelectrormotive force produced in the first sensor unit and a polarity of thermoelectromotive force produced in the second sensor unit are in mutually opposite polarity relationship when a heat flow passes through the first sensor unit and the second sensor unit in the same direction.

### CROSS-REFERENCE TO RELATED APPLICATION

This application is based on and claims the benefit of priority from earlier Japanese Patent Application No. 2021-128436 filed Aug. 4, 2021, the description of which is incorporated herein by reference.

### BACKGROUND

### Technical Field

The present disclosure relates to a state detecting sensor.

### Description of the Related Art

A state detection sensor is known. For a conventional state detection sensor, a state detection sensor is provided with a first heat flow sensor, a second heat flow sensor and a thermal buffer plate. The first heat flow sensor outputs a first sensor signal depending on a direction and a quantity of heat flow passing therethrough. The second heat flow sensor outputs a second sensor signal depending on a direction and a quantity of heat flow passing therethrough. The thermal buffer plate has a predetermined thermal capacity. Note that a heat quantity per unit time (i.e. movement of thermal energy) refers to a heat flow quantity. A heat quantity per unit time and unit area refers to a heat flux.

### SUMMARY

The present disclosure provides a state detection sensor and manufacturing method thereof capable of reducing thermal capacity of heat buffer body compared to a conventional state detection sensor

As a first aspect of the present disclosure, a state detection sensor is provided with a first sensor unit, a second sensor unit, an intermediate insulation sensor disposed between the first sensor unit and the second sensor unit. The first surface of the intermediate insulation layer is joined to the second wiring of the first sensor unit. The second surface of the intermediate insulation layer is joined to the third wiring of the second sensor unit. The first sensor unit and the second sensor unit are electrically connected in series in a state where a polarity of thermoelectromotive force produced in the first sensor unit and a polarity of thermoelectromotive force produced in the second sensor unit are in mutually opposite polarity relationship when a heat flow passes through the first sensor unit and the second sensor unit in the same direction.

### BRIEF DESCRIPTION OF THE DRAWINGS

In the accompanying drawings:

FIG. 1 is a plan view of a state detection sensor according to a first embodiment of the present disclosure;

FIG. 2 is a cross-sectional view sectioned along a line II-II shown in FIG. 1;

FIG. 3 is a flowchart showing a manufacturing method of the state detection sensor according to the first embodiment;

FIG. 4 is a disassembled view of a laminate formed by a lamination process shown in FIG. 3;

FIG. 5 is a cross-sectional view of a state detection sensor according to a comparative example 1;

FIG. 6 is a cross-sectional view of a state detection sensor according to a second embodiment;

FIG. 7 is a plan view showing a state detection sensor according to a third embodiment;

FIG. 8 is a cross-sectional view sectioned along a line shown in FIG. 7;

FIG. 9 is a disassembled view of a laminate formed in a lamination process in the manufacturing of a state detection sensor according to a third embodiment;

FIG. 10 is a diagram showing a planar layout of a first electrode, a first intermediate electrode and a first gold plating part, and a planar layout of a second electrode, a second intermediate electrode and a second gold plating part in a state detection sensor according to a fourth embodiment;

FIG. 11 is a diagram showing a planar layout of a plurality of first wirings and a planar layout of a plurality of fourth wirings in the state detection sensor according to the fourth embodiment;

FIG. 12 is a diagram showing a planar layout of a plurality of first thermal members and a plurality of second thermal members of a first substrate in the state detection sensor of the fourth embodiment;

FIG. 13 is a diagram showing a planar layout of a plurality of second wirings and one-side wiring and a planar layout of a plurality of third wirings and the other-side wiring in the state detection sensor according to the fourth embodiment;

FIG. 14 is a diagram showing a planar layout of a plurality of first thermal members of a plurality of second thermal members of a second substrate in the state detection sensor of the fourth embodiment;

FIG. 15 is a cross-sectional view of the first substrate illustrating a process for filling a first forming material into a plurality of first through holes of the first substrate in the manufacturing method of the state detection sensor of the fourth embodiment;

FIG. 16 is a diagram showing a plan view of a first mask used in a process shown in FIG. 15;

FIG. 17 is a cross-sectional view of the first substrate illustrating a process for tilling a second forming material into a plurality of first through holes of the first substrate in the manufacturing method of the state detection sensor of the fourth embodiment;

FIG. 18 is a diagram showing a plan view of a second mask used in a process shown in FIG. 17;

FIG. 19 is a cross-sectional view of a second substrate illustrating a process for filling a first forming material into a plurality of second through holes of the second substrate in the manufacturing method of the state detection sensor of the fourth embodiment;

FIG. 20 is a cross-sectional view of a second substrate illustrating a process for filling a second forming material into a plurality of second through holes of the second substrate in the manufacturing method of the state detection sensor of the fourth embodiment; and

FIG. 21 is a cross-sectional view of a state detection sensor according to a fifth embodiment.

### DETAILED DESCRIPTION OF THE PREFERRED EMBODIMENTS

For an example of a state detection sensor, Japanese Patent Application Laid-Open Publication No. 2016-80577 discloses a state detection sensor. The state detection sensor is provided with a first heat flow sensor, a second heat flow sensor and a thermal buffer plate. The first heat flow sensor outputs a first sensor signal depending on a direction and a quantity of heal flow passing therethrough. The second heat flow sensor outputs a second sensor signal depending on a direction and a quantity of heat flow passing therethrough. The thermal buffer plate has a predetermined thermal capacity. Note that a heat quantity per unit time (i.e. movement of thermal energy) refers to a heat flow quantity. A heat quantity per unit time and unit area refers to a heat flux.

A thermal buffer plate is interposed between the first heat flow sensor and the second heat flow sensor. The thermal buffer plate is joined to each of the first heat flow sensor and the second heat flow sensor by a joining member such as a heat transfer sheet having adhesive properties. The first heat flow sensor and the second heat flow sensor are arranged to have opposite polarities between the first sensor signal and the second sensor signal when heat-flows pass through the respective first heat flow sensor and second heat flow sensor in the same direction. The first heat flow sensor and the second heat flow sensor are electrically connected in series. Hence, the state detection sensor outputs a signal which combines the first sensor signal and the second sensor signal.

When the heat flow to be detected passes through the state detection sensor, the heat flow passes through the first heat flow sensor, the thermal buffer plate and the second heat flow sensor in this order. At this moment, the heat passed through the first heat flow sensor is accumulated in the thermal buffer plate. Thereafter, heat is radiated from the thermal buffer plate towards the second heat flow sensor. Hence, in a state where regular heat flow passes through the state detection sensor, the quantities of the heat flow passing through respective heat flow sensors are the same when comparing them at the same timing. On the other hand, in the case where the heat flow periodically changes, passes through the state detection sensor, the heat quantities of the heat flow passing through the respective heat flow sensor are different when comparing them at the same timing. Accordingly, with this state detection sensor, regular heat flow is cancelled and the heat flow which periodically changes can be measured.

According to the above-described state detection sensor, the thermal capacity of the thermal buffer plate is set depending on the changing period of the heat flow to be measured. The thermal capacity of the thermal buffer plate is required to be set such that the higher the change rate of the heat flow; the smaller the thermal capacity is. This is because, in the case where the heat is accumulated in the thermal buffer plate, subsequent change in the heat flow cannot be detected till the heat is radiated from the thermal buffer plate.

However, according to the above-described state detection sensor, since the thermal buffer plate is interposed between the two plates where the heat flow sensors are disposed, some degree of thickness is required for the thermal buffer plate. Further, a joining member is required for the thermal buffer plate to be joined with the heat flow sensors. The joining member serves as a thermal buffer body that accumulates and radiates heat. In other words, the thermal buffer plate together with the joining member serves as the thermal buffer body. Therefore, there is a limit by which the thermal capacity of the thermal buffer body can be reduced, between two plates of heat flow sensors.

Hereinafter, with reference to the drawings, embodiments of the present disclosure will be described. Note that the same reference numbers are applied to portions which are mutually the same or equivalent through the following embodiments.

### First Embodiment

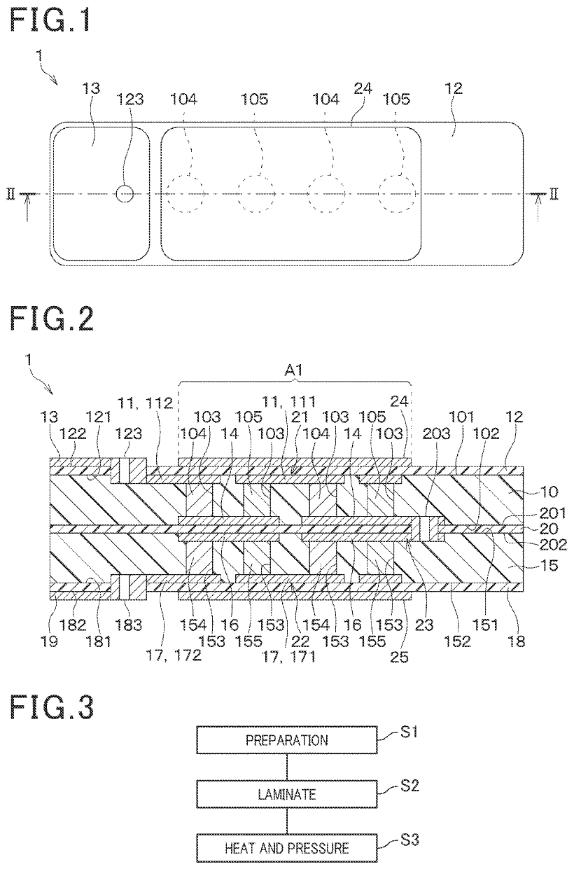

A state detection sensor 1 shown in FIGS.1 and 2 is formed in a plate shape having a first surface and a second surface opposite to the one surface. The state detection sensor 1 has a multiples layers laminated in a thickness direction orthogonal to the one surface and the second surface. Specifically, the state detection sensor 1 is provided with a first substrate 10, a plurality of first wirings 11, a first insulation layer 12, a first electrode 13, a plurality of second wirings 14, a second substrate 15, a plurality of third wirings 16, a plurality of fourth wirings 17, a second insulation layer 18, a second electrode 19 and an intermediate insulation layer 20.

The first substrate 10 is made of thermosetting resin such as polyimide and has electrical insulation properties. The first substrate 10 is formed in a film shape, having a first surface 101 and a second surface 102 in an opposite side of the first surface 101. In the first substrate 10, a plurality of first through holes 103 are formed from the first surface 101 to reach the second surface 102. In the plurality of first through holes 103, each of a plurality of first thermal members 104 and each of a plurality of second thermal members 105 are alternately arranged.

The plurality of first thermal member 104 and the plurality of second thermal members 105 are configured of thermal material having characteristics of mutually converting between thermal energy and electrical energy. The first thermal member 104 is configured of first conductive type thermal material. As a first conductive type thermal member, for example, sintered alloy of Bi—Sb—Te as a P-type semiconductor material is utilized. The second thermal member 105 is configured of a second conductive type thermal member which is different from the first conductive type thermal member. As the second thermal member 105, for example, sintered alloy of Bi—Te as a N-type semiconductor material is utilized.

The plurality of first wirings 11 are provided in a first surface 101 side of the first substrate 10. The plurality of first wirings 11 are made of conductive material and patterned to be in a predetermined planar shaped film. The plurality of first wirings 11 include a single first wiring 111 for connecting between thermal members. The first wiring 111 for connecting between the thermal members connects one first thermal member 104 in the plurality of first thermal members 104 with one second thermal member 105 in the plurality of second thermal members 105.

The plurality of first wirings 11 include one first wiring 112 used for connecting an electrode. The first writing 112 used for connecting an electrode serves as a wiring for electrically connecting either the first thermal member 104 or the second thermal member 105 with the first electrode 13.

The first insulation layer 12 is provided in a first surface 101 side of the first substrate 10. The first insulation layer 12 covers the plurality of first wirings 11. The first insulation layer 12 is made of thermosetting resin same as that of the first substrate 10 and has insulation properties. The first insulation layer 12 is formed in a film shape. The first insulation layer 12 is in contact with the plurality of first wiring 11 and a portion exposed from the plurality of first wiring 11 on the first surface 101 of the first substrate 10. The first insulation layer 12 includes a first surface 121 which is a surface in the first wiring 11 side and a second surface 122 which is opposite to the first wiring 11 side.

The first electrode 13 is formed on the second surface 122 of the first insulation layer 12. The first electrode 13 is made of conductive material and patterned to be in a predetermined planar shaped film. The first electrode 13 is electrically connected to the first wiring 112 used for connecting an electrode, via a through hole 123 formed in the first insulation layer 12. The through hole 123 includes a conductive film formed on the inner surface of the through hole which penetrating through the insulation layer. The conductive film serves as an interlayer connection member that connects wirings on both sides of the insulation layer.

A plurality of second wirings 14 are provided in a second surface 102 side of the first substrate 10. The plurality of second wirings 14 are made of conductive material and patterned to be in a predetermined planar shaped film. The plurality of second wirings 14 each connects one first thermal member 104 in the plurality of first thermal members 104 with one second thermal member 105 in the plurality of second thermal members 105.

The second substrate 15 is provided in a second surface 102 side of the first substrate 10. The second substrate 15 is made of a material that is the same as that of the first substrate 10.

The second substrate 15 is formed in a film shape, having a third surface 151 and a fourth surface 152 on an opposite side to the third surface 151. The third surface 151 is a surface of the second substrate 15 on a side facing the first substrate 10. The fourth surface 152 is a surface of the substrate 15 which is positioned facing away from the first substrate 10.

In the second substrate 15, a plurality of second through holes 153 are formed from the third surface 151 to reach the fourth surface 152, In the plurality of second through holes 153, each of a plurality of first thermal members 154 and each of a plurality of second thermal members 155 are alternately arranged. The plurality of first thermal members 154 of the second substrate 15 are configured of the same material as that of the plurality of first thermal members 104 of the first substrate 10. That is, the plurality of first thermal members 154 of the second substrate 15 are configured of the first conductive type thermal material. The plurality of thermal members 155 of the second substrate 15 are configured of the same material as that of the plurality of second thermal members 105 of the first substrate 10. That is, the plurality of thermal members 155 of the second substrate 15 are configured of a second conduction type thermal material.

Each of the plurality of first thermal members 154 of the second substrate 15 is provided at a portion facing a corresponding one of the plurality of first thermal members 104 of the first substrate 10 in a thickness direction of the state detection sensor 1. Each of the plurality of second thermal members 155 of the second substrate 15 is provided at a portion facing one of the plurality of second thermal members 105 of the first substrate

The plurality of third wirings 16 are provided in a third surface 151 side of the second substrate 15. The plurality of third wirings 16 is made of conductive material and patterned to be in a predetermined planar shaped film. The plurality of third wirings 16 each connects one first thermal member 154 in the plurality of first thermal members 154 with one second thermal member 155 in the plurality of second thermal members 155.

The plurality of fourth wirings 17 are provided in a fourth surface 152 side of the second substrate 15. The plurality of fourth wirings 17 are made of conductive material and patterned to be in a predetermined planar shaped film. The plurality of fourth wirings 17 include a single fourth wiring 171 for connecting between thermal members. The fourth wiring 171 for connecting between thermal members connects one first thermal member 154 in the plurality of first thermal members 154 with one second thermal members 155 in the plurality of second thermal members 155.

The plurality of fourth wirings 17 include one fourth wiring 172 used for connecting an electrode. The fourth writing 172 used for connecting an electrode serves as a wiring for electrically connecting either the first thermal member 154 or the second thermal member 155 with the second electrode 19.

The second insulation layer 18 is provided in a fourth surface 152 side of the second substrate 15. The second insulation layer 18 covers the plurality of fourth wirings 17. The second insulation layer 18 is made of the same material as that of the first insulation layer 12 and has insulation properties. The first insulation layer 12 is formed in a film shape. The second insulation layer 18 is formed in a film shape. The second insulation layer 18 is in contact with the plurality of fourth wirings 17 and a portion exposed from the plurality of fourth wirings 17 on the fourth surface 152 of the second substrate 15. The second insulation layer 18 is formed on a first surface 181 which is a surface in the fourth wiring 17 side and a second surface 182 which is opposite to the fourth wiring 17 side.

The second electrode 19 is formed on the second surface 182 of the second insulation layer 18. The second electrode 19 is made of conductive material and patterned to be in a predetermined planar shaped film. The second electrode 19 is electrically connected to the fourth wiring 172 used for connecting an electrode, via a through hole 183 formed in the second insulation layer 18.

The intermediate insulation layer 20 is provided between the first substrate 10 and the second substrate 15. The intermediate layer 20 is made of the same material as that of the first insulation layer 12 and has insulation properties. The intermediate insulation layer 20 is formed in a film shape, having a first surface 201 and a second surface 202 opposite to the first surface 201. The first surface 201 of the intermediate insulation layer 20 is joined to the plurality of second wirings 14 and a portion exposed from the plurality of second wirings 14 on the second substrate 102 of the first substrate 10. The second surface 202 of the intermediate insulation layer 20 is joined to the plurality of third wirings 16 and a portion exposed from the plurality of third wirings 15 on the third surface 141 of the second substrate 15. The thickness of the intermediate layer 20 is approximately from 20 μm to 200 μm.

With the first wiring 111 for connecting between thermal members and the plurality of second wirings 14, each of the plurality of first thermal member 104 provided in the first substrate 10 and each of the plurality of second thermal members 105 provided in the first substrate 10 are alternately connected in series. A conductor constituted by the first thermal member 104 and the second thermal member 105 alternately connected in series constitutes a first sensor unit 21.

With the plurality of third wirings 16 and the fourth wiring 171 for connecting between thermal members, each of the plurality of first thermal members 154 provided in the second substrate 15 and each of the plurality of second thermal members 155 provided in the second substrate 15 are alternately connected in series. A conductor constituted by the first thermal member 154 and the second thermal member 155 alternately connected in series constitutes a second sensor unit 22.

The first sensor unit 21 and the second sensor unit 22 are configured such that an absolute value of amount of thermoelectromotive force produced in the first sensor unit 21 and an absolute value of amount of thermoelectromotive force produced in the second sensor unit 22 are the same when the same quantity of heat flow passes through the first sensor unit 21 and the second sensor unit 22. Note that, the first sensor unit 21 and the second sensor unit 22 may be configured such that the difference between the absolute value of amount of thermoelectromotive force produced in the first sensor unit 21 and the absolute value of amount of thermoelectromotive force produced in the second sensor unit 22 is less than or equal to a predetermined value.

Further, the first sensor unit 21 and the second sensor unit 22 are configured such that the polarity of the thermoelectromotive force produced in the first sensor 21 and the polarity of the thermoelectromotive force produced in the second sensor 22 are in a mutually opposite polarity relationship when the heat flow passes through the first sensor unit 21 and the second sensor unit 22 in the same direction. The first sensor unit 21 and the second sensor 22 are electrically connected in series in a state of a mutually opposite polarity relationship between the polarity of the thermoelectromotive force produced in the first sensor 21 and the polarity of the thermoelectromotive force produced in the second sensor 22 when the heat flow passes through the first sensor unit 21 and the second sensor unit 22 in the same direction.

The electrical connection between the first sensor unit 21 and the second sensor unit 22 is accomplished by electrically connecting the second wiring 14 positioned at one end side (i.e. first end side) of the first sensor unit 21 and the third wiring 16 positioned at one end side of the second sensor 22 via the through hole 203 formed in the intermediate insulation layer 20.

The first electrode 13 is connected to one end side (i.e. first end side) of a connection body in which the first sensor unit 21 and the second sensor 22 are connected in series. The second electrode 19 is connected the other end side (i.e. second end side) of the connection body. The connection body constitutes a sensor main body 23.

The state detection sensor 1 is provided with a first gold plating part 24 and a second gold plating part 25. The first gold plating part 24 is formed on the second surface 122 of the first insulation layer 12 in a sensor area A1 of the state detection sensor 1. The sensor region A1 is a region where a plurality of first thermal members 104, 154 and a plurality of second thermal members 105 and 155 are arranged. The first gold plating part 24 is not electrically connected to the first electrode 13. The second gold plating part 25 is formed on the second surface 182 of the second insulation layer 18 in the sensor region A1. The second gold plating part 25 is not electrically connected to the second electrode 19. The first gold plating part 24 and the second gold plating part 25 cover the sensor region A1, thereby preventing the plurality of first thermal members 104, 154 and the plurality of second thermal members 105 and 155 from being oxidized.

Next, a manufacturing method of the state detection sensor 1 according to the present embodiment will be described. As shown in FIG. 3, the manufacturing method includes a preparation process S1, a lamination process S2 and heat-pressurization

process S3. In the preparation process S1, five layers including the first insulation layer 12, the first substrate 10, the intermediate layer 20, the second substrate 15 and the second insulation layer 18 which are shown in FIG. 5 are prepared.

The plurality of first wirings 11 are formed on the first surface 121 of the first insulation layer 12 to be prepared. The first electrode 13 and the first gold plating part 24 are formed on the second surface 122 of the first insulation layer. The through hole 123 which connects the first electrode 13 and the first wiring 11 is formed in the first insulation layer 12.

In the first substrate 10 to be prepared, a plurality of first through holes 103 are formed from the first surface 101 to reach the second surface 102. A first forming material 31 for forming the plurality of first thermal members 104 and a second forming material 32 for forming the plurality of second thermal members 105 are filled in the plurality of first through holes 103. As the first forming material 31, for example, a paste material is utilized in which organic solvent is added to P-type powdered Bi—Sb—Te alloy and pasted, As the second forming material 32, for example, a paste material is utilized in which organic solvent is added to N-type powdered Bi—Sb—Te alloy and formed as a paste.

The plurality of second wirings 14 are formed on the first surface 201 of the intermediate insulation layer 20 to be prepared. The plurality of third wirings 16 are formed on the second surface 202 of the intermediate insulation layer 20. In the intermediate insulation layer 20, the through hole 203 that connects between the second wiring 14 and the third wiring 1 6 is formed.

In the second substrate 15 to be prepared, a plurality of second through holes 153 are formed from the third surface 151 to reach the fourth surface 152. The first forming material 31 for forming the plurality of first thermal members 154 and the second forming material 32 for forming the plurality of second thermal members 155 are filled in the plurality of second through holes 153. The first forming material 31 of the second substrate 15 is the same material as that of the first forming material 31 of the first substrate 10.

The plurality of fourth wirings 17 are formed on the first surface 181 of the second insulation layer 18 to be prepared. The second electrode 19 and the second gold plating part 25 are formed on the second surface 182 of the second insulation layer 18. In the second insulation layer 18, the through hole 183 that connects between the second electrode 19 and the fourth wiring 17 is formed.

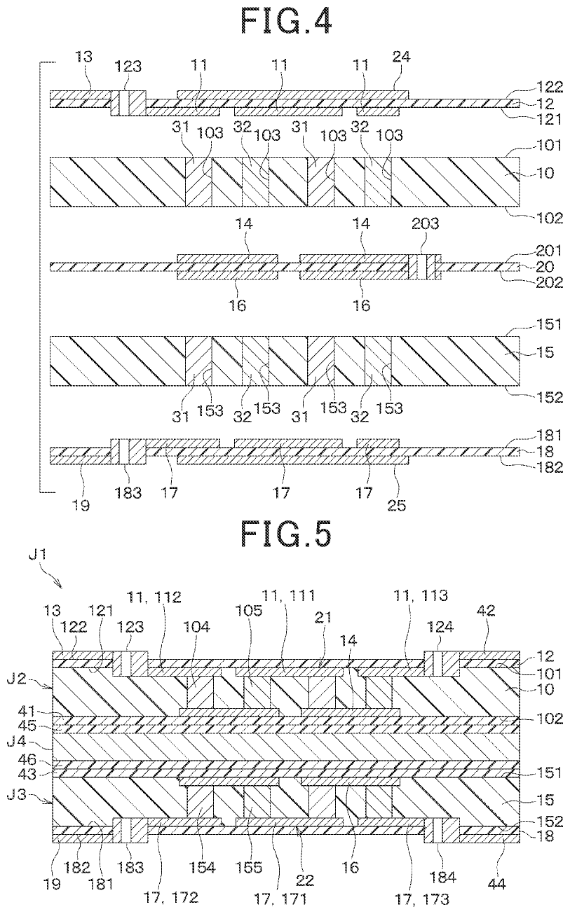

After the preparation process SI, the lamination process S2 is performed. In the lamination process S2, as shown in FIG. 4, five layers of the first insulation layer 12, the first substrate 10, the intermediate insulation layer 20, the second substrate 15 and the second insulation layer 18 are laminated in one direction in this order to form the laminate, At this time, the first surface 121 of the first insulation layer 12 faces the first substrate 10. The first surface 201 of the intermediate layer 20 faces the first substrate 10. The first surface 181 of the second insulation layer 18 faces the second substrate 15. The five layers are laminated to be in this state.

After the lamination process S2, the heat-pressurization process S3 is performed. In the heat-pressurization process S3, the laminate is pressurized in one direction while being heated. Thus, in the first substrate 10, powders contained in the first and second forming materials 31 and 32 are sintered to form the plurality of first and second thermal members 104 and 105 of the first substrate 10. The plurality of first and second thermal members 104 and 105, and the plurality of first and second wirings 11 and 14 are joined by diffusion joining. Similarly, in the second substrate 20, powders contained in the first and second forming materials 31 and 32 are sintered to form the plurality of first and second thermal members 154 and 155 of the second substrate 15. The plurality of first and second thermal members 154 and 155 and the plurality of third and fourth wirings 16 and 17 are joined by diffusion joining. The first substrate 10 and the second substrate 15, and insulation layers of the first insulation layer 12, the intermediate insulation layer 20 and the second insulation layer 18 are joined by fusion or via an adhesive layer which is not shown. Thus, the state detection sensor 1 shown in FIG. 2 is produced.

Next, a sensor signal outputted by the state detection sensor 1 according to the present embodiment will be described.

The heat flow passes through the state detection sensor 1 in the thickness direction of the state detection sensor 1. At this moment, thermoelectromotive force is produced in the first sensor unit 21, which depends on the direction of the heat flow passing through the first sensor unit 21 and the quantity thereof. Further, thermoelectromotive force is produced in the second sensor unit 22, which depends on the direction of the heat flow passing through the second sensor unit 22 and the quantity thereof. Note that the heat quantity per time unit refers to a heat flow quantity.

The first sensor unit 21 and the second sensor 22 are electrically connected in series in a state of mutually opposite polarity relationship between the polarity of the thermoelectromotive force produced in the first sensor unit 21 and the polarity of the thermoelectromotive force produced in the second sensor unit 22 when the heat flow passes through the first sensor unit 21 and the second sensor unit 22 in the same direction. The first electrode 13 is connected to the first end side of the sensor main body 23 to which the first sensor unit 21 and the second sensor unit 22 are connected. The second electrode 19 is connected to the second end side of the sensor main body 23. Hence, the state detection sensor 1 outputs the sum of the thermoelectromotive force of the first sensor unit 21 and the thermoelectromotive force of the second sensor unit 22. The outputted sensor signal is, for example, a voltage signal.

Next, detection of a state of an object to be detected (detection object) by the state detection sensor 1 will be described. The state detection sensor 1 is provided at a portion capable of detecting heat flow from the detection object. The heat flow emitted from the detection object passes through the state detection sensor 1 in the order of the first sensor unit 21, the intermediate insulation layer 20 and the second sensor unit 22. At this time, the heat passed through the first sensor unit 21 is accumulated in the intermediate insulation layer 20. The heat is radiated from the intermediate insulation layer 20 to the second sensor unit 22. Hence, in a state where regular heat flow passes through the state detection sensor 1, the quantities of the heat flow passing through respective sensor units 21 and 22 are the same. On the other hand, in the case where the heat flow which periodically changes, passes through the state detection sensor, the heat quantities of the heat flow passing through the respective sensor units are different when comparing them at the same timing. Hence, according to the state detection sensor 1, regular heat flow is cancelled and the heat flow which periodically changes can be measured. When the state of the detection object changes, the heat flow changes. Accordingly, by detecting the change in the heat flow, the state of the detection object can be detected.

Note that, unlike the present embodiment, an output waveform that corresponds to the output result of the state detection sensor 1 according to the present embodiment can be obtained by a software calculation. However, according to the present embodiment, since the signal depending on a change in the heat flow is directly outputted from the state detection sensor 1, information about a change in the heat flow can be obtained earlier than by software calculation.

Next, effects and advantages of the state detection sensor 1 according to the present embodiment will be described comparing with a state detection sensor J1 of a comparative example 1 shown in FIG. 5. Similar to the state detection sensor disclosed in the above-described patent literature, the detection sensor J1 of the comparative example 1 has a thermal buffer plate J4 interposed between the first heat flow sensor J2 and the second heat flow sensor J3.

Similar to the state detection sensor 1 according to the present embodiment, the first heat flow sensor J2 is provided with a first substrate 10 including a plurality of first thermal member 104 and a plurality of second thermal members 105, a plurality of first wirings 11, a first insulation layer 12, a first electrode 13 and a plurality of second wirings 14. Further, the first heat flow sensor J2 is provided with an insulation layer 41 and a second electrode 42. The insulation layer 41 is provided on a second surface side of the first substrate 10. The insulation layer 41 covers a plurality of second wirings 14. The insulation layer 41 is made of thermosetting resin same as that of the first substrate 10. The insulation layer 41 is formed in a film shape. The insulation layer 41 is in contact with the plurality of second wirings 14 and a portion exposed from the plurality of first wirings 14 on the second surface 102 of the first substrate 10. Similar to the first electrode 13, the second electrode 42 is formed on the second surface 122 of the first insulation layer 12. The second electrode 42 is electrically connected to the first wiring 113 used for connecting an electrode in the plurality of first wirings 11, via a through hole 124 formed in the first insulation layer 12.

Similar to the state detection sensor 1 according to the present embodiment, the second heat flow sensor J3 is provided with a second substrate 15 including a plurality of first thermal members 154 and a plurality of second thermal members 155, a plurality of third wirings 16, a plurality of fourth wirings 17, a second insulation layer 18 and a third electrode 19. The third electrode 19 is the same as the second electrode 19 of the state detection sensor 1 according to the present embodiment. Further, the second heat flow sensor J3 is provided with an insulation layer 43 and a fourth electrode 44. The insulation layer 43 is provided in the third surface 151 side of the second substrate 15, The insulation layer 43 covers the plurality of third wirings 16. The insulation layer 43 is made of thermosetting resin same as that of the second substrate 15. The insulation layer 43 is formed in a film shape. The insulation layer 43 is in contact with the plurality of third wirings 16 and a portion exposed from the plurality of third wiring 16 on the third surface 151 of the second substrate 15. Similar to the third electrode 19, the second electrode 44 is formed on the second surface 182 of the second insulation layer 18. The fourth electrode 44 is electrically connected to the fourth wiring 173 used for connecting an electrode in the plurality of fourth wirings 17, via a through hole 184 formed in the second insulation layer 18.

The thermal buffer plate J4 is formed separately from the first heat flow sensor J2 and the second heat flow sensor J3. The thermal buffer plate J4 is a plate made of metal, resin or the like. The first flow sensor J2 and the thermal buffer plate J4 are joined with each other via a first joining member 45 such as a heat transfer sheet having adhesive properties or a thermal transfer paste. The second heat flow sensor J3 and the thermal buffer plate J4 are joined with each other via a second joining member 46 such as a heat transfer sheet having adhesive properties or a thermal transfer paste.

The first heat flow sensor J2 outputs a sensor signal depending on the direction of the heat flow and heat quantity thereof passing through the first sensor unit 21. The second heat flow sensor J3 outputs a sensor signal depending on the direction of the heat flow and the heat quantity thereof passing through the second sensor unit 22. The first heat flow sensor J2 and the second heat flow sensor J3 are arranged such that the polarity of the first sensor signal and the polarity of the second sensor signal are mutually inverted in the case where direction of the heat flows passing through respective first heat flow sensor J2 and the second heat flow sensor J3 are the same. The first heat flow sensor J2 and the second heat flow sensor J3 are electrically connected in series via an external wiring which is not shown. Hence, the state detection sensor J1 according to the comparative example 1 outputs a sensor signal which combines the first sensor signal and the second sensor signal.

When the heat flow to be detected passes through the state detection sensor J1 according to the comparative example 1, the heat flow passes through either one heat flow sensor between the first heart flow sensor J2 and the second heat flow sensor J3, the heat buffer plate J4, the first heat flow sensor J2, and the other heat flow sensor between the first heat flow sensor J2 and the second heat flow sensor J3. At this moment, the heat buffer plate J4 accumulates and radiates heat. Accordingly, with this state detection sensor J1, regular heat flow is cancelled and the heat flow which periodically changes can be measured.

The thermal capacity of the heat buffer plate J4 is set depending on the period of a change in the heat flow to be detected. The thermal capacity of the heat buffer plate J4 is required to be set such that the higher the speed of change in the heat flow; the smaller the thermal capacity of the heat buffer plate J4 is. This is because, when the heat remains in the heat buffer plate J4. subsequent heat change cannot be detected till the heat is radiated from the heat buffer plate J4.

However, according to the state detection sensor J1 of the comparative example 1, the insulation layer 41 of the first heat flow sensor J2, the first joining member 45. the heat buffer plate J4, the second joining member 46 and the insulation layer 43 of the second heat flow sensor J3 are present between the first sensor unit 21 and the second sensor 22. Since these layers, members and plate serve as a heat buffer body which accumulates and radiates heat, the thermal capacity of the heat buffer body is difficult to reduce.

In contrast, in the state detection sensor 1 according to the present embodiment, the intermediate insulation layer 20 between the first sensor unit 21 and the sensor unit 22 serves as a heat buffer body that accumulates and radiates heat. The state detection sensor 1 according to the present embodiment does not include the heat buffer plate J4 and the first and second joining members 45 and 46 that join the heat buffer plate J4 which are provided in the state detection sensor J1 according to the comparative example 1. Further, according to this state detection sensor 1, a single intermediate layer 20 is utilized instead of the insulation layers 41 and 43 provided in the respective two heat flow sensor J2 and J3 in the state detection sensor J1 of the comparative example 1. Because of these reasons, according to the state detection sensor 1, compared to the state detection sensor J1 of the comparative example 1, the thermal capacity of the heat buffer body between the first sensor unit 21 and the second sensor uni22 can be smaller.

Further, for manufacturing the state detection sensor J1 of the comparative example 1, a manufacturing process that produces each of the two heat flow sensors J2 and J3, and a bonding process in which the heat buffer plate J4 is interposed between two heat flow sensors J2 and J3 and is bonded therebetween are required, Hence, manufacturing the state detection sensor requires much time.

In the manufacturing method of the state detection sensor 1 according to the present embodiment, the first insulation layer 12, the first substrate 10, the intermediate insulation layer 20, the second substrate 15 and the second insulation layer 18 are heated and pressurized at the same time. Thus, the state detection sensor 1 is produced in which the intermediate insulation layer 20 is present between the first sensor unit 21 and the second sensor unit 22. Accordingly, the sensor manufacturing processing and the bonding process in the manufacturing of the state detection sensor J1 of the comparative example 1 can be integrated. According to the manufacturing method of the state detection sensor 1 of the present embodiment, compared to the manufacturing method of the state detection sensor J1 of the comparative example 1, the manufacturing process can be simplified. Thus, manufacturing time can be reduced.

### Second Embodiment

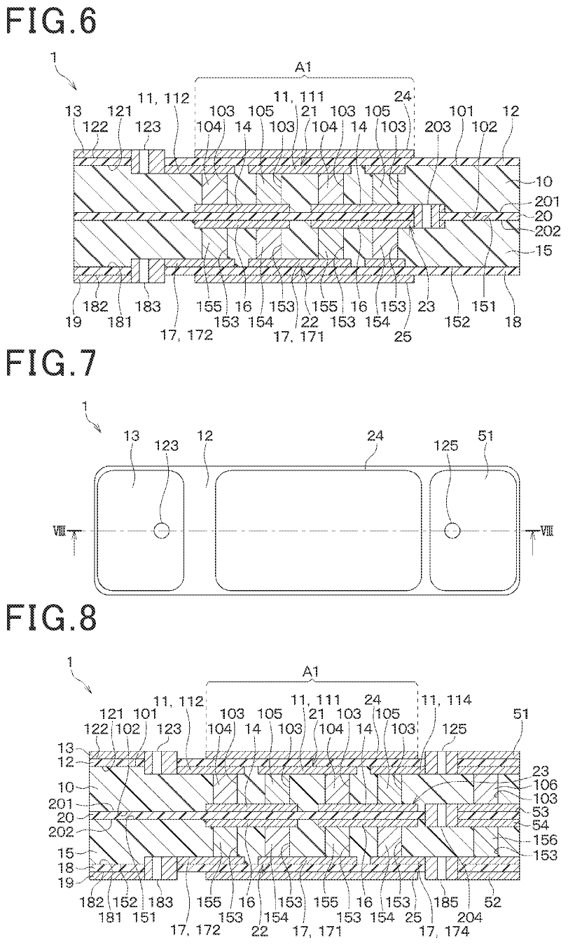

As shown in FIG. 6, in the state detection sensor 1 according to the present embodiment, each of the plurality of first thermal members 154 of the second substrate 14 is provided at a portion facing, in the thickness direction of the state detection sensor 1, each of the plurality of second thermal members 105 of the first substrate 10. Each of the plurality of second thermal members 155 of the second substrate 15 is provided at a portion facing, in the thickness direction of the state detection sensor 1, each of the plurality of first thermal member 104 of the first substrate 10. Other configurations of the state detection senor 1 are the same as those in the first embodiment. The manufacturing method of the state detection sensor 1 is the same as that of the first embodiment except for the arrangement of the plurality of first thermal members 154 of the second substrate 15 and the plurality of second thermal members 155.

In the manufacturing of the state detection sensor 1, the thickness of the thermal member after the heat-pressurization process S3 is sometimes different between the plurality of first thermal members 104 and 154, and the plurality of second thermal members 105 and 155. This is because an amount of deformation after heat-pressurization process in the first forming material 31 for forming the plurality of first thermal members 104 and 154 and an amount of deformation after heat-pressurization process in the second forming material 32 for forming the plurality of second thermal member 105 and 155 are different, For example, in the case where P-type powdered Bi—Sb—Te alloy is utilized as the first forming material 31 and P-type powdered Bi—Sb—Te alloy is utilized as the second forming material 32, the thickness of the plurality of second thermal members 105 and 155 is smaller than that of the plurality of first thermal members 104 and 154.

Hence, similar to the state detection sensor 1 of the first embodiment, in the first substrate 10 and the second substrate 15, when the same conductive type thermal members are arranged facing with each other in the thickness direction of the state detection sensor 1, a thinner portion of the first substrate 10 corresponds to a thinner portion of the second substrate 15. Hence, variation in the thickness of the state detection sensor 1 becomes significant.

In this regard, according to the present embodiment, since the same conductive type thermal members are arranged not to face with each other in the thickness direction of the state detection sensor 1, variation in the thickness of the state detection sensor 1 can be suppressed.

According to the present embodiment, all of the plurality of first thermal members 154 of the second substrate 14 face the plurality of second thermal members 105 of the first substrate 10, and all of the plurality of second thermal members 155 of the first substrate 10 face the plurality of first thermal members 104 of the first substrate 10. The present embodiment is not limited to these configurations. Hence, only a part of the plurality of first thermal members 154 may face the second thermal member 105 of the first substrate 10, and only a part of the plurality of second thermal members 155 may face the first thermal member 104 of the first member 10.

In short, one first thermal member 154 of a plurality of first thermal members 154 of the second substrate 15 may face one second thermal members 155 of the plurality of second thermal members 155 of the first substrate 10 in a thickness direction of the state detection sensor 1. One second thermal member 155 of the plurality of second thermal members 155 of the second substrate 15 may face one first thermal member 104 of the plurality of first thermal members 104 of the first substrate 10 in a thickness direction of the state detection sensor 1. Thus, variation in the thickness of the state detection sensor 1 can be suppressed compared to a case where the same conductive type thermal members face with each other in the thickness direction of the state detection sensor 1 in the whole plurality of first thermal members 154 and the plurality of second thermal members 155

### Third Embodiment

As shown in FIGS. 7 and 8, the state detection sensor 1 of the present embodiment is provided with a first intermediate electrode 51 and a second intermediate electrode 52 as an intermediate electrode. Similar to the first electrode 13, the first intermediate electrode 51 is formed on the second surface 122 of the first insulation layer 12. The second intermediate electrode 52 is provided at a portion facing the first intermediate electrode 51 in the thickness direction of the state detection sensor 1. The second intermediate electrode 52 is formed on the second substrate 182 of the second insulation layer 18 similar to the second electrode 19. The second intermediate electrode 52 is provided at a portion facing the first intermediate electrode 51 in the thickness direction of the state detection sensor 1.

The first intermediate electrode 51 and the second intermediate electrode 52 are electrically connected between the first sensor unit 21 and the second sensor unit 22.

Specifically, the first intermediate electrode 51 is electrically connected to the first wiring 114 used for connecting an electrode in the plurality of first wirings 11 of the first sensor unit 21 via the through hole 125 formed on the first insulation layer 12. The first wiring 114 used for connecting an electrode serves as a wiring for electrically connecting either the first thermal member 104 or the second thermal member 105 with the first intermediate electrode 51. Thus, the first intermediate electrode 51 is electrically connected to an opposite side of the first electrode 13 in the first sensor unit 21

The second intermediate electrode 52 is electrically connected to the fourth wiring 174 used for connecting an electrode in the plurality of fourth wirings 17 of the second sensor unit 22 via the through hole 185 formed on the second insulation layer 18.

The fourth wiring 174 used for connecting an electrode serves as a wiring for electrically connecting either the first thermal member 154 or the second thermal member 145 with the second intermediate electrode 52. Thus, the second intermediate electrode 52 is electrically connected to an opposite side of the second electrode 19 in the second sensor unit 22.

The first wiring 114 used for connecting an electrode and the fourth wiring 174 used for connecting an electrode are electrically connected via a connection-thermal member 106 of the first substrate 10 and a connection-thermal member 156 of the second substrate 15

The connection-thermal member 106 is provided at one first through hole 103 in the plurality of first through holes 103 formed on the first substrate 10. The connection-thermal member 106 is provided at a portion facing, in the thickness direction of the state detection sensor 1, the first intermediate electrode 51 in the first substrate 10. The connection-thermal member 106 is formed by the same material as one of either the first thermal member 104 or the second thermal member 105 of the first substrate 10. The connection-thermal member 106 is connected to the first wiring 114 used for connecting an electrode. The connection-thermal member 106 is connected to the first surface side wiring 53 formed on the first surface 201 of the intermediate layer 20.

The connection-thermal member 156 is provided at one second through hole in the plurality of second through holes 153 formed on the second substrate 15. The connection-thermal member 156 is provided at a portion in the second substrate 15, facing the first intermediate electrode 51 in the thickness direction of the state detection sensor 1. The connection thermal member 156 is made of the same thermal material as that of either the first thermal member 154 or the second thermal member 155 of the second substrate 15. The connection-thermal member 156 is connected to the fourth wiring 174 used for connecting an electrode. The connection-thermal member 156 is connected to the second surface side wiring 54 formed on the second surface 20 of the intermediate insulation layer 20. The second surface side wiring 54 is electrically connected to the first surface side wiring 53 via the though hole 204 formed on the intermediate insulation layer 20.

Other configurations of the state detection sensor 1 according to the present embodiment are the same as those in the state detection sensor according to the first embodiment.

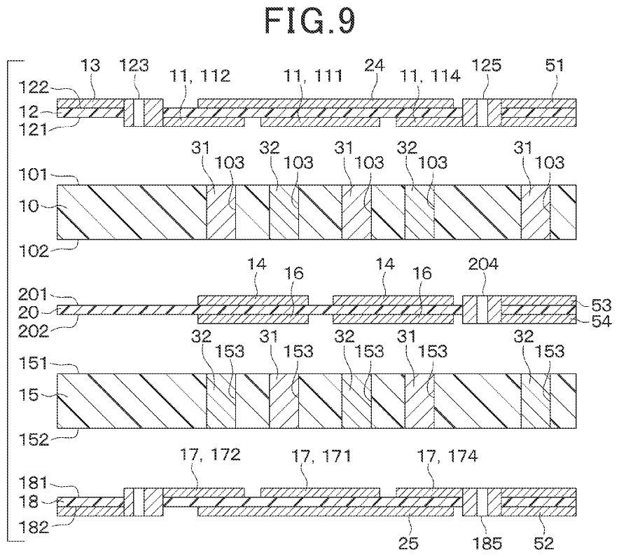

A manufacturing method of the state detection sensor 1 of the present embodiment includes, similar to the first embodiment, the preparation process Si, the lamination process S2 and the heat-pressurization process S3. Each layer prepared in the preparation process S1 is different from that of the first embodiment, Other processes are the same as those in the first embodiment. As shown in FIG. 9, the first intermediate electrode 51 is formed on the second surface 122 of the first insulation layer 12 prepared in the preparation process S1. In the first insulation layer 12, the through hole 125 is formed that connects between the first intermediate electrode 51 and the first wiring 11.

In the prepared first substrate 10, a plurality of first through holes 103 are formed. The plurality of first through holes 103 includes a first through hole 103 used for forming the connection-thermal member 106. The first forming material 31 is filled in the first through hole 103. Other configurations in the first substrate 10 are the same as those in the first embodiment.

The first surface side wiring 53 is formed on the first surface 201 of the prepared intermediate insulation layer 20. The second surface side wiring 54 is formed on the second surface 202 of the intermediate insulation layer 20. In the intermediate insulation layer 20, the through hole 204 is formed on the insulation layer 20 to connect between the first surface side wiring 53 and the second surface side wiring 54. Other configurations in the intermediate insulation layer 20 are the same as those in the first embodiment.

In the prepared second substrate 15, a plurality of second though holes 153 are formed. The plurality of second through holes 153 includes a second through hole 153 for forming the connection-thermal member 156. The second forming material is formed in the second through hole 153. Other configurations of the second substrate 15 are the same as those in the first embodiment.

The second intermediate electrode 52 is formed on the second surface 182 of the prepared second insulation layer 18, In the second insulation layer 18, the through hole 185 that connects between the second intermediate electrode 52 and the fourth wirings 17. Other configurations of the second insulation layer 18 are the same as those in the second insulation layer 18.

Next, effects and advantages obtained from the state detection sensor 1 of the present embodiment will be described comparing with the state detection sensors of the comparative example 1 and the first embodiment. When respective state detection sensors are manufactured, a characteristic test is performed for securing the sensor characteristics.

According to the state detection sensor J1 of the comparative example 1 shown in FIG. 5, the first heat-flow sensor J2 and the second heat flow sensor J3 are connected by an external wiring. With this configuration outputs of respective heat flow sensors of the first heat flow sensor J2 and the second heat flow sensor J3 can be measured. Hence, as a characteristics test, a method of applying constant heat flow to the state detection sensor can be employed. In the method of applying constant heat flow to the state detection sensor, a heat-source plate is in contact with the state detection sensor. The heat-source plate applies constant heat flow to the state detection sensor. A measurement apparatus measures outputs of the respective heat flow sensors and calculates a thermal coefficient from the measurement values. The thermal coefficient is a conversion coefficient for converting the output values to be a heat flow quantity or a heat flux. The sensor characteristics of the respective heat flow sensors are determined to be proper when the calculated thermal coefficient is within a predetermines range. In the case where sensor characteristics of both hear flow sensors are correct the sensor characteristics of the state detection sensor are determined as proper, thereby ensuring the sensor characteristics thereof.

On the other hand, according to the state detection sensor 1 of the first embodiment shown in FIG. 2, the first sensor unit 21 and the second sensor unit 22 are electrically connected in series inside the state detection sensor 1. Hence, the outputs of the first sensor unit 21 and the second sensor unit 22 cannot be measured. Accordingly, as a method of characteristic test, a method of applying constant heat flow to the state detection sensor cannot be employed.

According to the state detection sensor 1 of the first embodiment, sum of the thermoelectromotive force of the first sensor unit 21 and the thermoelectromotive force of the second sensor unit 22 are outputted as a sensor signal. In the case where constant heat flow is applied to the state detection sensor, even when the sensor characteristics of the respective sensor units are not proper, if the absolute value of the thermoelectromotive force of the first sensor unit 21 and the absolute value of the thermoelectromotive force of the second sensor unit 22 are the same, the output value of the state detection sensor 1 is 0. That is, the output value of the state detection sensor 1 is the same as that of a case where the sensor characteristics of the respective sensor units are correct Therefore, although the sensor characteristics are not proper, the sensor characteristics are erroneously determined as proper so that the characteristics test cannot be appropriately performed.

As a method of characteristics test for the state detection sensor 1 according to the present embodiment, a method of periodically measuring an output of the state detection sensor 1 when being applied with a force can be utilized. According to this method, the state detection sensor 1 is attached to an apparatus that applies mechanical stress, in a state where the state detection sensor 1 is positioned between two plate-like elastic members. With this method, heat flow produced when the stress is applied to the two elastic members is applied to the state detection sensor 1. The measurement apparatus measures the output of the state detection sensor 1 acquired at this time. Then, output values acquired through repeatedly performed measurements are compared. The sensor characteristics are determined as proper when the compared output values are the same.

However, since this method is a dynamic test, when the stress is applied to two elastic members, rattling may be produced in the detection object. Hence, measurement error is likely to occur. The method for applying heat flow is a static test. Therefore, measurement error is small. In this respect, the method for applying heat flow may preferably be utilized.

The state detection sensor 1 according to the present embodiment is provided with the first intermediate electrode 51 and the second intermediate electrode 52. The first electrode 13 is electrically connected to the first end side of the first sensor unit 21. The first intermediate electrode 51 is electrically connected to the second end side of the first sensor unit 21. The first electrode 13 and the first intermediate electrode 51 are connected to the measurement apparatus (not shown), whereby the output of the first sensor unit 21 can be measured. The second electrode 19 is electrically connected to the first end side of the second sensor unit 22. The second intermediate electrode 52 is electrically connected to the second end side of the second sensor unit 22. The second electrode 19 and the second intermediate electrode 52 are connected to a measurement apparatus which is not shown, whereby the output of the second sensor unit 22 can be measured.

Hence, according to the state detection sensor 1 of the present embodiment, as a method of characteristics test, a method of applying constant heat flow to the state detection sensor can be employed. The measurement apparatus measures outputs of the respective sensor units of the first sensor unit 21 and the second sensor unit 22, and calculates thermal coefficient from the measured values. When the calculated thermal coefficient is within a predetermined range, the sensor characteristics of the respective sensor units are determined as proper, and the sensor characteristics of the state detection sensor 1 are ensured.

Further, according to the state detection sensor 1 of the present embodiment, the following effects and advantages can be obtained.

(1) The state detection sensor 1 according to the present embodiment is provided with a first intermediate electrode 51 and the second intermediate electrode 52 in addition to the first electrode 13 and the second electrode 19. Hence, the state detection sensor 1 is able to output, depending on manner of connecting between these electrodes and the measurement apparatus, at least one of a sensor signal responding to heat quantity of the heat flow radiated from an detection object and a sensor signal responding to a change in the heat flow radiated from the detection object.

Specifically, the first electrode 13 and the first intermediate electrode 51 are connected to the measurement apparatus. Thus, a sensor signal responding to the direction of the heat flow passing through the first sensor unit 21 and the heat quantity thereof can be outputted. Further, the second electrode 19 and the second intermediate electrode 52 are connected to the measurement apparatus. Thus, a sensor signal responding to the direction of the heat flow passing through the second sensor unit 22 and the heat quantity thereof can be outputted. Furthermore, the first electrode 13 and the second intermediate electrode 19 are connected to the measurement apparatus. Thus, a sensor signal responding to a change in the heat flow passing through sensor main body 23 can be outputted.

Also, all of the above connections are performed, whereby the sensor signal responding to the direction of the heat flow passing through the first sensor unit 21 and the heat quantity thereof, the sensor signal responding to the direction of the heat flow passing through the second sensor unit 22 and the heat quantity thereof, and the sensor signal responding to a change in the heat flow passing through sensor main body 23 can be outputted.

Thus, the state detection sensor 1 of the present disclosure can be used as a heat flow sensor, a state detection sensor, or a sensor having both of the heat flow sensor and the state detection sensor functions.

(2) In the state detection sensor 1 according to the present embodiment, the first sensor unit 21 and the second sensor unit 22 are electrically connected via the connection-thermal members 106 and 156. The connection-thermal member 106 and 156 are provided in a region facing the first intermediate electrode 51 in the state detection sensor 1 in the thickness direction of the state detection sensor 1. That is, the connection-thermal members 106 and 156 are provided in a region different from the sensor region A1 in the state detection sensor 1. Hence, an influence from the connection-thermal members 106 and 105 on the sensor signal of the first sensor unit 21, the sensor signal of the second sensor unit 22 and the sensor signal of the sensor main body 23 can be minimized.

### Fourth Embodiment

The state detection sensor 1 has a cross-sectional structure shown in FIG. 8 similar to that of the state detection sensor 1 according to the third embodiment. However, according to the state detection sensor 1 of the present embodiment, as described later, the number of the plurality of first thermal members 104 and 154, the plurality of second thermal members 105 and 155, and the planar layout thereof are different from that of the state detection sensor 1 of the third embodiment. Note that, the planar layout of later-described each member is viewed from a first electrode 13 side of the state detection sensor 1.

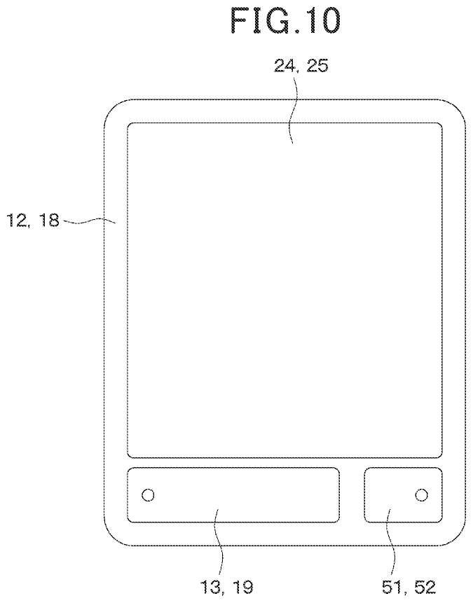

As shown in FIG. 10, the first electrode 13, the first intermediate electrode 51 and the first gold plating part 24 are arranged on the surface of the first insulation layer 12. The first electrode 13 and the first intermediate electrode 51 are arranged at one side in a first direction with respect to the gold plating part 24. The first electrode 13 and the first intermediate electrode 51 are arranged in a direction orthogonal to the first direction.

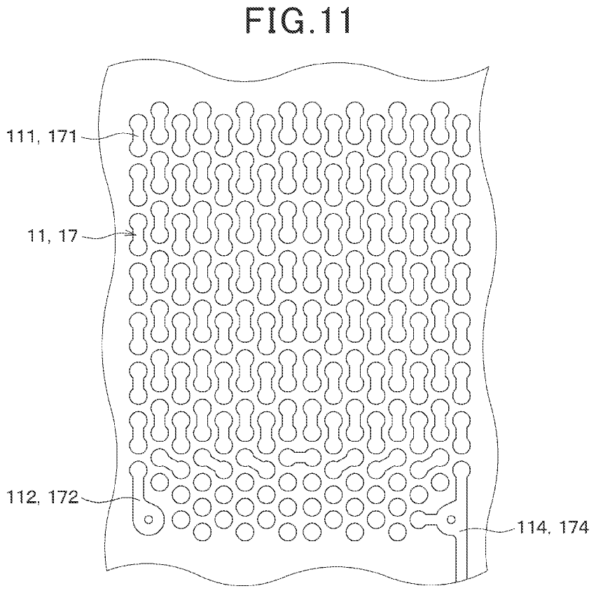

As shown in FIG. 11, a plurality of first wirings 11 are arranged. According to the present embodiment, the plurality of first wirings include a plurality of first wirings 111 for connecting between thermal members. The most part of first wirings 111 for connecting between the thermal members have a shape extending in the vertical direction in FIG. 11. A part of the first wirings 112 for connecting electrodes is provided at a portion corresponding to the first electrode 13 shown in FIG. 10. A part of the first wirings for connecting electrodes is provided at a portion corresponding to the first intermediate electrode 51 shown in FIG. 10.

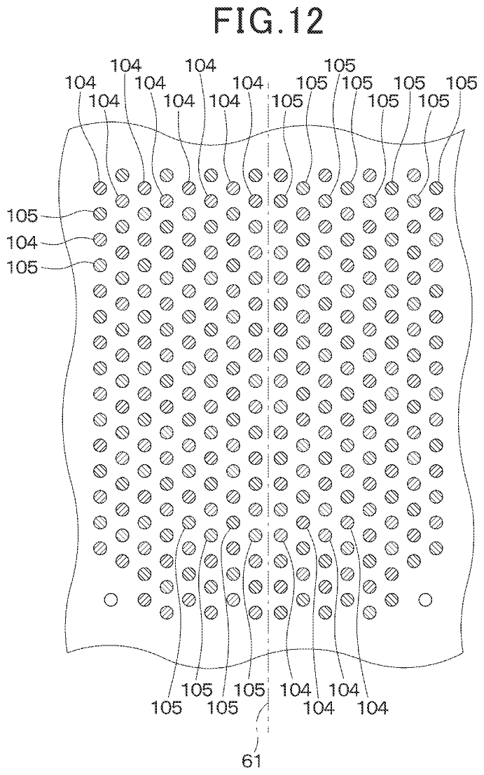

The plurality of first thermal members 104 and the plurality of second thermal members 105 of the first substrate 10 are arranged as shown in FIG. 12. In FIG. 12, in order to readily discern the first thermal member 104 and the second thermal member 105, hatchings are applied in different direction for the first thermal member 104 and the second thermal member 105. The respective first thermal members 104 and respective second thermal members 105 are alternately arranged in the vertical direction in FIG. 12.

The plurality first thermal members 104 are arranged in line-symmetry with respect to the plurality of second thermal members 105, of which the symmetric axis is a virtual line 61 parallel to the vertical direction in FIG. 12. Specifically, the plurality of first thermal members 104 arranged in the left side portion relative to the virtual line 61 are arranged in line-symmetry with respect to the plurality of second thermal members 105 arranged in the right side portion relative to the virtual line 61. The plurality of first thermal members 104 arranged in the right side portion relative to the virtual line 61 are arranged in line-symmetry with respect to the plurality of second thermal members 105 arranged in the left side portion relative to the virtual line 61. Note that the left side portion corresponds to the first side and the right side portion corresponds to the second side.

The respective first thermal members 104 arranged in one side in the left-side direction (horizontal direction) relative to the virtual line 61 in FIG. 12 are arranged to zigzag in the horizontal direction with intervals therebetween. The respective second thermal members 105 arranged on one side in the horizontal direction relative to the virtual line 61 in FIG. 12 are arranged to zigzag in the horizontal direction with intervals therebetween.

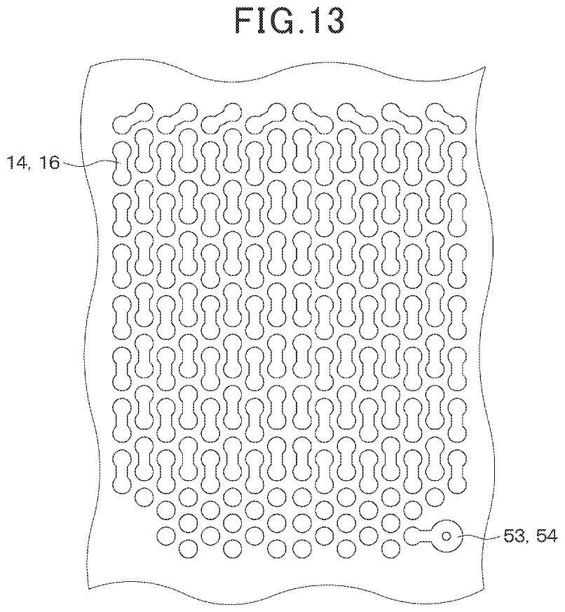

As shown in FIG. 13, the plurality of second wirings 14 and the first surface side wiring 53 are arranged. Most of the plurality of second wirings 14 have a shape extending in the vertical direction in FIG. 13. The first surface side wiring 53 is provided at a portion corresponding to the first intermediate electrode 51 shown in FIG. 10.

As shown in FIG. 13, the plurality of third wirings 16 and the second surface side wirings 54 are arranged similar to the plurality of second wirings 14 and the first surface side wirings 53. Hence, in FIG. 13, both the reference numbers of the second wirings 14 and the first surface side wirings 53 and the reference numbers of the third wirings 16 and the second surface side wirings 54 are applied.

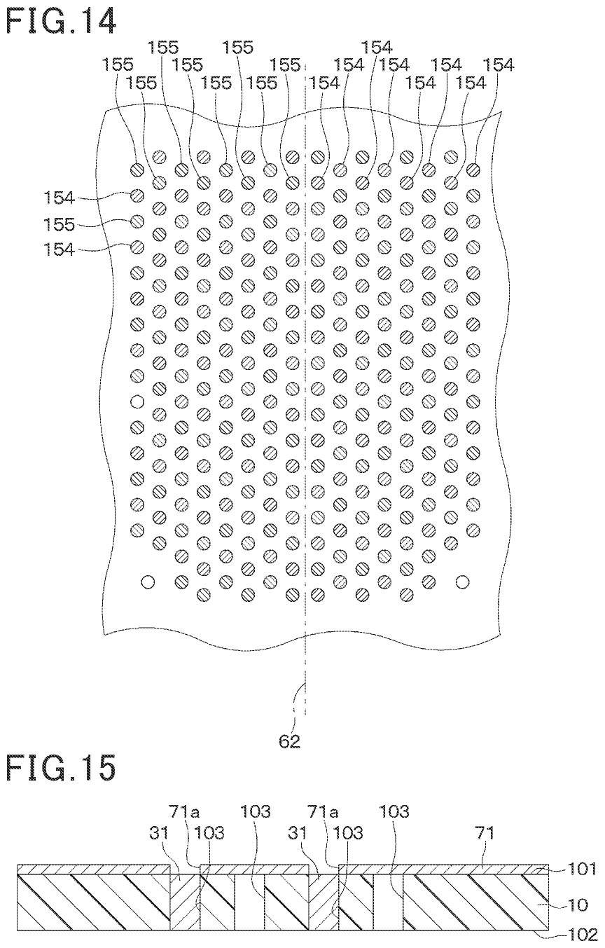

As shown in FIG. 14, the plurality of first thermal members 154 and the plurality of second thermal members 155 of the second substrate 15 are arranged. in FIG. 14, in order to readily discern the first thermal member 154 and the second thermal member 155, hatchings are applied in different direction for the first thermal member 154 and the second thermal member 155. The direction of the hatching for the first thermal member 154 is the same as that of the first thermal member 104 shown in FIG. 12. The direction of the hatching for the second thermal member 155 is the same as that of the second thermal member 105 shown in FIG. 12.

The plurality of first thermal members 154 and the plurality of second thermal members 155 are arranged at portions where the first thermal member and the second member are exchanged referring to an arrangement of the plurality of first thermal members 104 and the plurality of second thermal members 105 of the first substrate 10 shown in FIG. 12. In other words, when the second substrate 15 is projected on the first substrate 10 in the thickness direction of the state detection sensor 1, the plurality of first thermal members 154 of the second substrate 15 are arranged at portions which are the same as those of the second thermal member 105 of the first substrate 10 shown in FIG. 12. The plurality of second thermal members 155 of the second substrate 15 are arranged at portions Which are the same as those of the first thermal member 104 of the first substrate 10 shown in FIG. 12.

As shown in FIG. 11, the plurality of fourth wirings 17 are arranged similarly to the plurality of first wirings 11. Hence, in FIG. 11, both the reference numbers of the first wirings 11 and the fourth wirings 17 are applied. The plurality of fourth wirings 17 includes a plurality of fourth wirings 171 for connecting between the thermal members. Most part of the plurality of fourth wirings for connecting thermal members have a shape extending in the vertical direction shown in FIG. 11. A part of the fourth wirings 172 for connecting electrodes is provided at a portion corresponding to the first electrode 13 shown in FIG. 10. A part of the fourth wirings for connecting electrodes is provided at a portion corresponding to the first intermediate electrode 51 shown in FIG. 10.

As shown in FIG. 10, respective second electrode 19, the second intermediate electrode 52 and the second gold plating part 25 are provided, on the surface of the second insulation layer 18, at portions facing, in the thickness direction of the state detection sensor 1, respective first electrode 13, the first intermediate electrode 51 and the first gold plating part 24. In FIG. 10, both of the reference numbers of the first insulation layer 12, the first electrode 13, the first intermediate electrode 51 and the first gold plating part 24, and the reference numbers of the second insulation layer 18, the second electrode 19, the second intermediate electrode 52 and the second gold plating part 25 are applied. Note that the second electrode 19, the second intermediate electrode 52 and the second gold plating part 25 are arranged at horizontally flipped portions of FIG. 10 on the surface of the second insulation layer 18.

The manufacturing method of the state detection sensor 1 according to the present embodiment includes, similar to that of the third embodiment, a preparation process S1, a lamination process S2 and heat-pressurization process S3. According to the present embodiment, preparation of the first substrate 10 in the preparation process S1 includes the following process.

That is, as shown in FIG. 15, the first forming material 31 is filled into a plurality of first through holes 103 formed on the first substrate 10 using a first mask 71. In FIG. 15, a part of first through holes 103 in the plurality of first through holes 103 are shown. The same applies to FIG. 17.

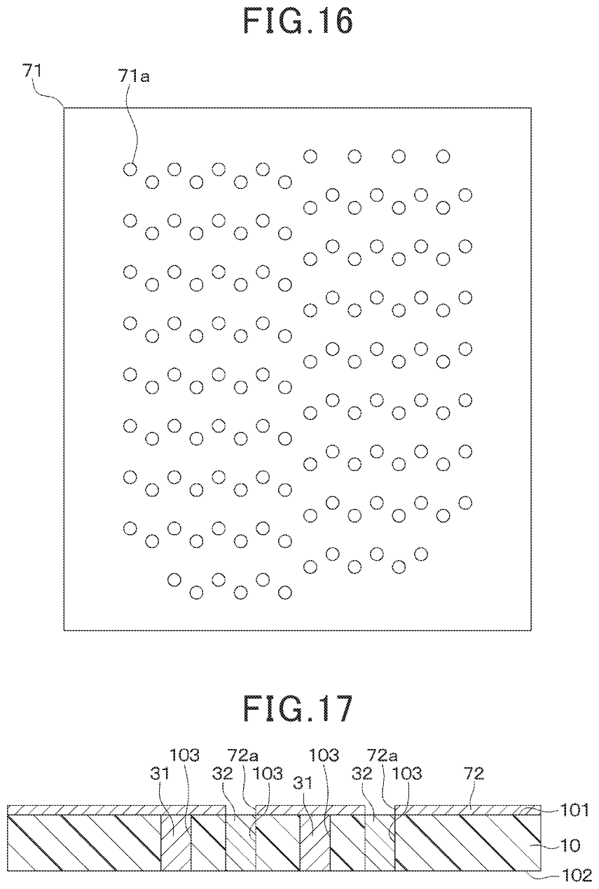

Specifically, the first mask 71 is provided on the first surface 101 of the first substrate 10 in which a plurality of first through holes 103 are formed. The first mask 71 serves as a jig having a plate-like shape, in which the jig assists the filling of the first forming material 31. As the first mask 71, for example, stainless plate may be used. As shown in FIG. 16, the first mask 71 includes a plurality of first openings 71a. The arrangement of the first openings 71.a is the same as that of the plurality of first thermal members 104 shown in FIG. 12. The arrangement of the first openings 71a when front and back surfaces of the first mask 71 are inverted is the same as that of the plurality of first thermal members 154 shown in FIG. 14. As shown in FIG. 15, the first mask 71 when being provided on the first substrate 10 makes the first through holes 103 open where the plurality of first thermal members 104 are to be formed, among the plurality of first through holes 103. The first mask 71 closes the first through hole 103 where the plurality of second thermal members 105 are to be formed among the plurality of first through holes 103. The first mask 71 covers a region excluding the plurality of first through holes 103 on the first surface 101 of the first substrate 10.

Then, although illustration is omitted, the first forming material 31 in a paste form is coated on the surface of the first mask 71. This first forming material 31 is pressed on the first mask 71 by squeegee device or the like. Thus, the first forming material 31 is filled into a part of the first through holes 103 among the plurality of first through holes 103. Thereafter, the first mask 71 is removed from the first substrate 10. Subsequently, as shown in FIG. 17, the second mask 72 is used to fill the second forming material 32 into the plurality of first through holes 103 formed on the first substrate 10.

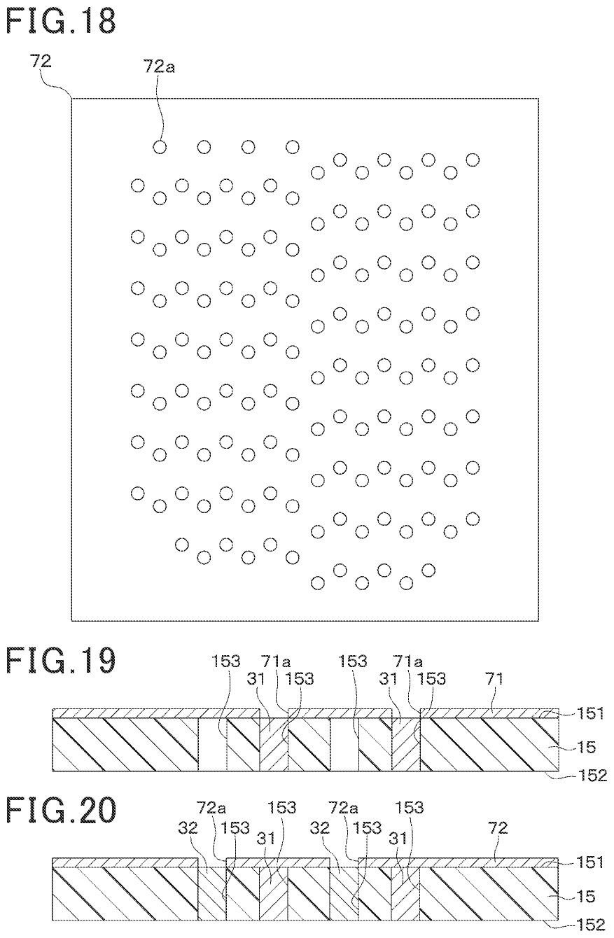

Specifically, the second mask 72 is provided on the first surface 101 of the first substrate 10. The second mask 72 serves as a jig having a plate-like shape, in which the jig assists the filling of the second forming material 32. As the second mask 72, for example, stainless plate may be used. As shown in FIG. 18, the second mask 72 includes a plurality of second openings 72a. The arrangement of the plurality of second openings 72a is the same as that of the plurality of second thermal members 105 shown in FIG. 12. The arrangement of the second openings 72a when front and back surfaces of the second mask 72 are inverted as shown in FIG. 18 is the same as that of the plurality of second thermal members 155 shown in FIG. 14. As shown in FIG. 17, the second mask 72 when being provided on the first substrate 10 makes the first through holes 103 open where the plurality of second thermal members 105 are to be formed, among the plurality of first through holes 103. The second mask 72 closes the first through hole 103 where the plurality of first thermal members 104 are to be formed among the plurality of first through holes 103. The second mask 72 covers a region excluding the plurality of first through holes 103 on the first surface 101 of the first substrate 10.

Then, although illustration is omitted, the second forming material 32 in a paste form is coated on the surface of the second mask 72. This second forming material 32 is pressed on the second mask 72 by squeegee device or the like. Thus, the second forming material 32 is filled into a part of the first through holes 103 among the plurality of first through holes 103. Thereafter, the second mask 72 is removed from the first substrate 10. Thus, the first substrate 10 is prepared in which the first forming material 31 and the second forming material 32 are filled into the plurality of first through holes 103.

Further, according to the present embodiment, preparation of the second substrate 15 in the preparation process S1 includes the following process.

That is, as shown in FIG. 19, the first forming material 31 is filled into a plurality of second through holes 153 formed on the second substrate 15 using the second mask 71. In FIG. 19, only some of the second through holes 153 in the plurality of second through holes 153 are shown. The same applies to FIG. 20.

Specifically, in a state where the front and back surfaces of the first mask 71 used for filling the first forming material 31 on the first substrate 10 are inverted, the first mask 71 is provided on the third surface 151 of the second substrate 15 where the plurality of second through holes 153 are formed. Thus, the first mask 71 when being provided on the second substrate 15 makes the second through holes 153 open where the plurality of first thermal members 154 are to be formed, among the plurality of second through holes 153. The first mask 71 closes the second through hole 153 where the plurality of second thermal members 155 are to be formed, among the plurality of second through holes 153. The first mask 71 covers a region excluding the plurality of second through holes 153 on the third surface 151 of the second substrate 15.

Then, although illustration is omitted, the first forming material 31 in a paste form is coated on the surface of the first mask 71. This first forming material 31 is pressed on the first mask 71 by squeegee device or the like. Thus, the first forming material 31 is filled into a part of the second through holes 153 among the plurality of second through holes 153. Thereafter, the first mask 71 is removed from the second substrate 15.

Subsequently, as shown in FIG. 20, the second mask 72 is used to fill the second forming material 32 into the plurality of second through holes 153 formed on the second substrate 15.

Specifically, in a state where the front and back surfaces of the second mask 72 used for filling the second forming material 32 on the first substrate 10 are inverted, the second mask 72 is provided on the first surface 101 of the first substrate 10. Thus, the second mask 72 when being provided on the second substrate 15 makes the second through holes 153 open where the plurality of second thermal members 155 are to be formed, among the plurality of second through holes 153. The second mask 72 closes the second through hole 153 where the plurality of first thermal members 154 are to be formed, among the plurality of second through holes 153. The second mask 72 covers a region excluding the plurality of second through holes 153 on the third surface 151 of the second substrate 15.

Then, although illustration is omitted, the second forming material 32 in a paste form is coated on the surface of the second mask 72. This second forming material 32 is pressed on the second mask 72 by squeegee device or the like. Thus, the second forming material 32 is filled into a part of the second through holes 153 among the plurality of second through holes 153. Thereafter, the second mask 72 is removed from the second substrate 15. Thus. the second substrate 15 is prepared in which the first forming material 31 and the second forming material 32 are filled into the plurality of second through holes 153.

Here, as shown in FIG. 8, respective first thermal members 154 of the second substrate 15 are arranged to face respective second thermal members 105 of the first substrate 10. The respective second thermal members 155 of the second substrate 15 are arranged to face the respective first thermal members 104 of the first substrate 10, However, the plurality of first thermal members 104 and the plurality of second thermal members 105 are not arranged in line-symmetry on the first substrate 10. A case will. be considered in which the plurality of first thermal members 154 and the second thermal member 155 are not arranged in line-symmetry on the second substrate 15.

In this case, four types of masks are required for a mask used for filling the first forming material 31 on the first substrate 10, a mask used for tilling the second forming material 32 on the first substrate 10, a mask used for filling the first forming material 31 on the second substrate 15 and a mask for filling the second forming material 32 on the second substrate 15.

Alternatively, for the above masks, two types of masks are required to be cleaned for use. That is, the mask used for filling the first material 31 on the first substrate 10 is cleaned. Then, the cleaned mask is used to fill the second forming material 32 on the second substrate 15. The mask used for filling the second forming material 32 on the first substrate 10 is cleaned. Then, the cleaned mask is used to fill the first forming material 31 on the second substrate 15. At this moment, the mask is required to be cleaned to avoid mixing different materials.

According to the present embodiment, similar to the cross-sectional structure shown in FIG. 8, respective first thermal members 154 of the second substrate 15 are arranged to face the respective second thermal members 105 of the first substrate 10 in the thickness direction of the state detection sensor 1. The respective first thermal members 155 of the second substrate 15 are arranged to face the respective first thermal members 104 of the first substrate 10 in the thickness direction of the state detection sensor 1. The respective first thermal members 104 of the first substrate 10 are arranged to have line-symmetry with the respective second thermal members 105 of the first substrate 10. The respective first thermal members 154 of the second substrate 15 are arranged to have line-symmetry with the respective second thermal members 155 of the second substrate 15.

Hence, a mask used for filling the first forming material 31 on the first substrate 10 and a mask used for filling the first forming material 31 on the second substrate 15 can be shared by inverting the front and back surfaces thereof. Further, a mask used for filling the second forming material 32 on the first substrate 10 and a mask used for filling the second forming material 32 on the second substrate 15 can be shared by inverting the front and back surfaces thereof.

Accordingly, compared to a case where four types of masks are used, the number of masks can be reduced. Also, compared to a case where two types of masks are cleaned for use, since a cleaning process for preventing different material from being mixed can be removed, the manufacturing process can be simplified.

### Fifth Embodiment

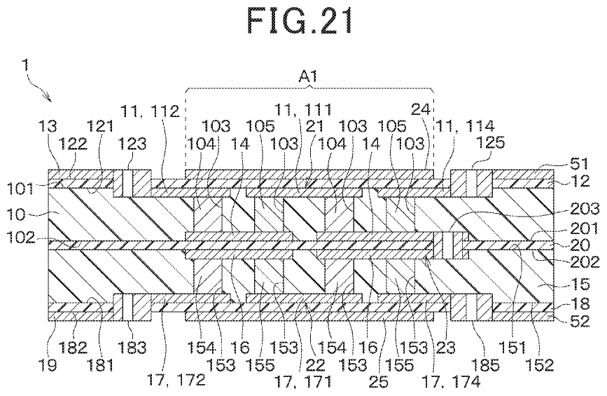

As shown in FIG. 21, the state detection sensor 1 of the present embodiment differs from the state detection sensor 1 of the third embodiment in that the first sensor unit 21 and the second sensor unit 22 are electrically connected via the through holes 203 formed on the intermediate insulation layer 20. According to the state detection sensor 1 of the present embodiment, positions of the first thermal members 154 of the second substrate 15 and the second thermal members 155 of the second substrate are inverted with respect the positions in the third embodiment, but they may be the same. Other configurations of the state detection sensor 1 are the same as those in the state detection sensor 1 of the third embodiment. Also, with the state detection sensor 1 of the present embodiment, similar to the state detection sensor 1 of the third embodiment, as a method of characteristics test, a method for applying a heat flow to the state detection sensor 1 can be employed.

Note that, according the state detection sensor 1 of the present embodiment, the second thermal members 104 directly connected to the first wiring 114 for connecting electrode serve as a thermoelectric transducer of the first sensor unit 21, but does not serve as a thermoelectric transduced of the sensor main body 23. Similarly, the second thermal members 155 directly connected to the fourth wirings 174 for connection electrode serve as a thermoelectric transducer of the second sensor unit 22, but do not serve as a thermoelectric transducer of the sensor main body 23. Thus, a thermal member which does not serve as a thermoelectric transduced is present in the sensor region A1, thereby causing an error in sensing by the sensor main body 23.

However, according to the state detection sensor 1 of the third embodiment, thermoelectric transducer which does not serve as thermoelectric transducer is not present in the sensor region A 1. In this respect, the state detection sensor 1 according to the third embodiment is better than the state detection sensor 1 of the present embodiment.

### Other Embodiments

(1) According to the third to fifth embodiments, the state detection sensor 1 is provided with the first intermediate electrode 51 and the second intermediate electrode 52 as an intermediate electrode. However, the state detection sensor 1 may include either the first intermediate electrode 51 or the second intermediate electrode 52. In this case, either one intermediate electrode is electrically connected between the first sensor unit 21 and the second sensor unit 22. With this configuration, the same effects and advantages as that of the third embodiment can be obtained.

(2) In the above-described embodiments, positions the first thermal members 104 and 154 and the second thermal members 105 and 155 may be exchanged.

(3) In the above-described embodiments, the plurality of first thermal members 104 of the first substrate 10 and the plurality of first thermal members 154 of the second substrate 15 are made of the same material. Also, the plurality of second thermal members 105 of the first substrate 10 and the plurality of second thermal members 155 of the second substrate 15 are made of the same material. However, the plurality of first thermal members 104 of the first substrate 10 and the plurality of first thermal members 154 of the second substrate 15 may be made of different materials as long as the conductive types are the same. Similarly, the plurality of second thermal members 105 of the first substrate 10 and the plurality of second thermal members 155 of the second substrate 15 may be made of different materials as long as the conductive types are the same.

Specifically, according to the above-described embodiments, although the first forming material 31 filled into the first through holes 103 in the preparation of the first substrate 10 and the first forming material 31 filled into the second through holes 153 in the preparation of the second substrate 15 are made of the same material, different materials may be used. Similarly, although the second forming material 32 filled into the first through holes 103 in the preparation of the first substrate 10 and the second forming material 32 filled into the second through holes 153 in the preparation of the second substrate 15 are made of the same material, different materials may be used.

(4) In the above-described embodiments, the first substrate 10, the first insulation layer 12, the second substrate 15, the second insulation layer 18 and the intermediate insulation layer 20 are made of the same material. However, the first substrate 10, the first insulation layer 12, the second substrate 15, the second insulation layer 18 and the intermediate insulation layer 20 may not be made of the same material as long as they are constituted of thermosetting resin.

(5) In the above-described embodiments, the interlayer connection by the though holes can be changed to an interlayer connection by via-contact.

(6) The present disclosure is not limited to the above-described embodiments, but may be appropriately modified within a scope of claims, including various modification examples and equivalents thereof. Moreover, the above-described embodiments can be appropriately combined except where embodiments are mutually related and apparently impossible to be combined. Further, in the above-described embodiments, elements constituting the embodiments are not necessarily required except where elements are clearly specified as necessary or theoretically necessary.

Even in the case where numeric values are mentioned in the above-described embodiments, such as the number of constituents, numeric values, quantity, range or the like, it is not limited to the specific values unless it is specified as necessary or theoretically limited to specific numbers. In the case where materials, shapes, positional relationships and the like are mentioned for the constituents in the above-described embodiments, it is not limited to the material, the shapes and positional relationships except that they are clearly specified or theoretically limited to specific material, shapes, positional relationships and the like.

(Conclusion)

The present disclosure provides a state detection sensor and manufacturing method thereof capable of reducing thermal capacity of heat buffer body compared to a conventional state detection sensor

As a first aspect of the present disclosure, a state detection sensor is provided including: a first substrate made of thermosetting resin, having a first surface and a second surface opposite to the first surface, a plurality of first through holes being formed from the first surface to reach the second surface, a plurality of first thermal members configured as a first conductive type and a plurality of second thermal members configured as a second conductive type different from the first conductive type being arranged in the plurality of first through holes such that respective first thermal members and respective second thermal members are alternately arranged on the plurality of first through holes;

one or more first wirings made of conductive material, provided on a first surface side of the first substrate, connecting one first thermal member in the plurality of first thermal members with one second thermal member in the plurality of second thermal members;

a first insulation layer made of thermosetting resin, provided on the first surface side of the first substrate, covering the one or more first wirings;

a first electrode made of conductive material, formed on a surface opposite to a first wiring side in the first insulation layer;

a plurality of second wirings made of conductive material, provided on a second surface side of the first substrate, connecting one first thermal member in the plurality of first thermal members with one second thermal member in the plurality of second thermal members;

a second substrate made of thermosetting resin, provided on the second surface side of the first substrate, having a third surface in a first substrate side and a fourth surface in an apart side of the first substrate, a plurality of second through holes being formed from the third surface to reach the fourth surface, the plurality of first thermal members configured as the first conductive type and the plurality of second thermal members configured as the second conductive type being arranged in the plurality of second through holes such that respective first thermal members and respective second thermal members are alternately arranged on the plurality of second through holes;

a plurality of third wirings made of conductive material, provided on a third surface side of the second substrate, connecting one first thermal member in the plurality of first thermal members of the second substrate with one second thermal member in the plurality of second thermal members of the second substrate;

one or more fourth wirings made of conductive material, provided on a fourth surface side of the second substrate, connecting one first thermal member in the plurality of first thermal members of the second substrate with one second thermal member in the plurality of second thermal member of the second substrate;

a second insulation layer made of thermosetting resin, provided on the fourth surface side of the second substrate, covering the one or more fourth wiring;

a second electrode made of conductive material, formed on a surface opposite to the fourth wiring side in the second insulation layer; and

an intermediate insulation layer made of thermosetting resin, provided between the first substrate and the second substrate, having a first surface and a second surface opposite to the first surface, the first surface being joined to the plurality of second wirings and a portion on the second surface of the first substrate which is exposed from the plurality of second wirings and the second surface being joined to the plurality of third wirings and a portion on the third surface of the second substrate which is exposed from the plurality of third wirings.

A first sensor unit is configured of a conductor in which respective first thermal members of the first substrate and respective second thermal members of the first substrate are alternately connected in series by the one or more first wirings and the plurality of second wirings; a second sensor unit is configured of a conductor in which respective first thermal members of the second substrate and respective second thermal members of the second substrate are alternately connected in series by the plurality of third wirings and the one or more fourth wirings; the first sensor unit and the second sensor unit are electrically connected in series in a state where a polarity of thermoelectromotive force produced in the first sensor unit and a polarity of thermoelectromotive force produced in the second sensor unit are in mutually opposite polarity relationship when a heat flow passes through the first sensor unit and the second sensor unit in the same direction: the first electrode is electrically connected to a first end side of a connection body in which the first sensor unit and the second sensor unit are connected in series: and the second electrode is electrically connected to a second end side of the connection body.

The state detection sensor according to the present disclosure, the intermediate insulation layer between the first sensor unit and the sensor unit serves as a heat buffer body that accumulates and radiates heat. The state detection sensor does not include the heat buffer plate and the joining member that join the heat buffer plate of conventional state detection sensor. Further, according to this state detection sensor, a single intermediate layer is utilized instead of the insulation layers provided in the respective two heat flow sensor provided in a conventional state detection sensor. Because of these reasons, according to the state detection sensor of the present disclosure, compared to conventional state detection sensor, the thermal capacity of the heat buffer body between the first sensor unit and the second sensor unit can be smaller.

As a fourth aspect of the present disclosure, a manufacturing method of the state detection sensor is provided including steps of:
preparing the first insulation layer in which the one or more first wirings are formed on the first surface and the first electrode is formed on the second surface;
preparing the first substrate provided with the plurality of first through holes formed therethrough, a first forming material to form the plurality of first thermal members of the first substrate and a second forming material to form the plurality of second thermal members of the second substrate being filled into the plurality of first through holes;
preparing the intermediate insulation layer including the plurality of second wirings formed on the first surface and the plurality of third wirings formed on the second surface;
preparing the second substrate provided with the plurality of second through holes formed therethrough, a first forming material to form the plurality of first thermal members of the second substrate and a second forming material to form the plurality of second thermal members of the second substrate being filled into the plurality of second through holes;
preparing the second insulation layer in which the one or more fourth wirings are formed on the first surface and the second electrode is formed on the second surface;
forming a laminate by laminating in the order of the first insulation layer, the first substrate, the intermediate insulation layer, the second substrate and the second insulation layer in one direction such that the first surface of the first insulation layer faces the first substrate, the first surface of the intermediate insulation layer faces the first substrate and the first surface of the second insulation layer faces the second substrate.

With this manufacturing method, the state detection sensor according to the above first aspect is produced. According to the state detection sensor produced by this manufacturing method, effects and advantages of the first aspect are obtained.

For manufacturing conventional state detection sensor, a manufacturing process that produces each of the two heat flow sensors, and a bonding process in which the heat buffer plate is interposed between two heat flow sensors and is bonded therebetween are required. Hence, manufacturing the state detection sensor requires much time.

In this respect, according to the manufacturing method of the state detection sensor of the present disclosure, the first insulation layer, the first substrate, the intermediate insulation layer, the second substrate and the second insulation layer are heated and pressurized at the same time. Thus, the state detection sensor is produced in which the intermediate insulation layer is present between the first sensor unit and the second sensor unit. Accordingly, the sensor manufacturing processing and the bonding process in the manufacturing of the conventional state detection sensor can be integrated. According to the manufacturing method of the state detection sensor of the present disclosure, compared to the manufacturing method of the conventional state detection sensor, the manufacturing process can be simplified. Thus, manufacturing time can be reduced.

What is claimed is:

1. A state detection sensor comprising:
a first substrate made of thermosetting resin, having a first surface and a second surface opposite to the first surface, a plurality of first through holes being formed from the first surface to reach the second surface, a plurality of first thermal members configured as a first conductive type and a plurality of second thermal members configured as a second conductive type different from the first conductive type being arranged in the plurality of first through holes such that respective first thermal members and respective second thermal members are alternately arranged on the plurality of first through holes;
one or more first wirings made of conductive material, provided on a first surface side of the first substrate, connecting one first thermal member in the plurality of first thermal members with one second thermal member in the plurality of second thermal members;
a first insulation layer made of thermosetting resin, provided on the first surface side of the first substrate, covering the one or more first wirings;
a first electrode made of conductive material, formed on a surface opposite to a first wiring side in the first insulation layer;
a plurality of second wirings made of conductive material, provided on a second surface side of the first substrate, connecting one first thermal member in the plurality of first thermal members with one second thermal member in the plurality of second thermal members;
a second substrate made of thermosetting resin, provided on the second surface side of the first substrate, having a third surface in a first substrate side and a fourth surface in an apart side of respect to the first substrate, a plurality of second through holes being formed from the third surface to reach the fourth surface, the plurality of first thermal members configured as the first conductive type and the plurality of second thermal members configured as the second conductive type being arranged in the plurality of second through holes such that respective first thermal members and respective second thermal members are alternately arranged in the plurality of second through holes;
a plurality of third wirings made of conductive material, provided on a third surface side of the second substrate, connecting one first thermal member in the plurality of first thermal members of the second substrate with one second thermal member in the plurality of second thermal members of the second substrate;
one or more fourth wirings made of conductive material, provided on a fourth surface side of the second substrate, connecting one first thermal member in the plurality of first thermal members of the second substrate with one second thermal member in the plurality of second thermal member of the second substrate;
a second insulation layer made of thermosetting resin, provided on the fourth surface side of the second substrate, covering the one or more fourth wiring;
a second electrode made of conductive material, formed on a surface opposite to the fourth wiring side in the second insulation layer; and
an intermediate insulation layer made of thermosetting resin, provided between the first substrate and the second substrate, having a first surface and a second surface opposite to the first surface, the first surface being joined to the plurality of second wirings and a portion on the second surface of the first substrate which is exposed from the plurality of second wirings and the second surface being joined to the plurality of third wirings and a portion on the third surface of the second substrate which is exposed from the plurality of third wirings, wherein
a first sensor unit is configured of a conductor in which respective first thermal members of the first substrate and respective second thermal members of the first substrate are alternately connected in series by the one or more first wirings and the plurality of second wirings;
a second sensor unit is configured of a conductor in which respective first thermal members of the second substrate and respective second thermal members of the second substrate are alternately connected in series by the plurality of third wirings and the one or more fourth wirings;
the first sensor unit and the second sensor unit are electrically connected in series in a state where a polarity of thermoelectromotive force produced in the first sensor unit and a polarity of thermoelectromotive force produced in the second sensor unit are in a mutually opposite polarity relationship when a heat flow passes through the first sensor unit and the second sensor unit in the same direction;
the first electrode is electrically connected to a first end side of a connection body in which the first sensor unit and the second sensor unit are connected in series; and
the second electrode is electrically connected to a second end side of the connection body.

2. The state detection sensor according to claim 1, wherein
the state detection sensor is provided with an intermediate electrode formed on at least either the surface of the first insulation layer and the surface of the second insulation layer, the intermediate electrode being electrically connected between the first sensor unit and the second sensor unit.

3. The state detection sensor according to claim 1, wherein
the plurality of first thermal members of the first substrate and the plurality of first thermal members of the second substrate are made of the same material:
the plurality of second thermal members of the first substrate and the plurality of second thermal members of the second substrate are made of the same material;
one first thermal member in the plurality of first thermal members of the second substrate faces one second thermal member in the plurality of second thermal members of the first substrate in a thickness direction of the state detection sensor; and
one second thermal member in the plurality of second thermal members of the second substrate faces one first thermal member in the plurality of first thermal members of the first substrate in a thickness direction of the state detection sensor.

4. A manufacturing method of a state detection sensor,
the state detection sensor comprising:
a first substrate made of thermosetting resin, having a first surface and a second surface opposite to the first surface, a plurality of first through holes being formed from the first surface to reach the second surface, a plurality of first thermal members configured as a first conductive type and a plurality of second thermal members configured as a second conductive type different from the first conductive type being arranged in the plurality of first through holes such that respective first thermal members and respective second thermal members are alternately arranged in the plurality of first through holes;
one or more first wirings made of conductive material, provided on a first surface side of the first substrate, connecting one first thermal member in the plurality of first thermal members with one second thermal member in the plurality of second thermal members;
a first insulation layer made of thermosetting resin, provided on the first surface side of the first substrate, covering the one or more first wirings;
a first electrode made of conductive material, formed on a surface opposite to a first wiring side in the first insulation layer;
a plurality of second wirings made of conductive material, provided on a second surface side of the first substrate, connecting one first thermal member in the plurality of first thermal members with one second thermal member in the plurality of second thermal members;
a second substrate made of thermosetting resin, provided on the second surface side of the first substrate, having a third surface in a first substrate side and a fourth surface in an apart side of the first substrate, a plurality of second through holes being formed from the third surface to reach the fourth surface, the plurality of first thermal members configured as the first conductive type and the plurality of second thermal members configured as the second conductive type being arranged in the plurality of second through holes such that respective first thermal members and respective second thermal members are alternately arranged on the plurality of second through holes;
a plurality of third wirings made of conductive material, provided on a third surface side of the second substrate, connecting one first thermal member in the plurality of first thermal members of the second substrate with one second thermal member in the plurality of second thermal members of the second substrate;
one or more fourth wirings made of conductive material, provided on a fourth surface side of the second substrate, connecting one first thermal member in the plurality of first thermal members of the second substrate with one second thermal member in the plurality of second thermal member of the second substrate;
a second insulation layer made of thermosetting resin, provided on the fourth surface side of the second substrate, covering the one or more fourth wiring;
a second electrode made of conductive material, formed on a surface opposite to the fourth wiring side in the second insulation layer; and
an intermediate insulation layer made of thermosetting resin, provided between the first substrate and the second substrate, having a first surface and a second surface opposite to the first surface, the first surface being lowed to the plurality of second wirings and a portion on the second surface of the first substrate which is exposed from the plurality of second wirings and the second surface being joined to the plurality of third wirings and a portion on the third surface of the second substrate which is exposed from the plurality of third wirings, wherein
a first sensor unit is configured of a conductor in which respective first thermal members of the first substrate and respective second thermal members of the first substrate are alternately connected in series by the one or more first wirings and the plurality of second wirings;
a second sensor unit is configured of a conductor in which respective first thermal members of the second substrate and respective second thermal members of the second substrate are alternately connected in series by the plurality of third wirings and the one or more fourth wirings;
the first sensor unit and the second sensor unit are electrically connected in series in a state where a polarity of thermoelectromotive force produced in the first sensor unit and a polarity of thermoelectromotive force produced in the second sensor unit are in mutually opposite polarity relationship when a heat flow passes through the first sensor unit and the second sensor unit in the same direction;
the first electrode is electrically connected to a first end side of a connection body in which the first sensor unit and the second sensor unit are connected in series; and
the second electrode is electrically connected to a second end side of the connection body,
the manufacturing method of the state detection sensor comprising steps of:
preparing the first insulation layer in which the one or more first wirings are formed on the first surface and the first electrode is formed on the second surface;
preparing the first substrate provided with the plurality of first through holes formed therethrough, a first forming material to form the plurality of first thermal members of the first substrate and a second forming material to form the plurality of second thermal members of the second substrate being filled into the plurality of first through holes;
preparing the intermediate insulation layer including the plurality of second wirings formed on the first surface and the plurality of third wirings formed on the second surface;
preparing the second substrate provided with the plurality of second through holes formed therethrough, a first forming material to form the plurality of first thermal members of the second substrate and a second forming material to form the plurality of second thermal members of the second substrate being filled into the plurality of second through holes;
preparing the second insulation layer in which the one or more fourth wirings are formed on the first surface and the second electrode is formed on the second surface;
forming a laminate by laminating in the order of the first insulation layer, the first substrate, the intermediate insulation layer, the second substrate and the second insulation layer in one direction such that the first surface of the first insulation layer faces the first substrate, the first surface of the intermediate insulation layer faces the first substrate and the first surface of the second insulation layer faces the second substrate.

5. The manufacturing method of the state detection sensor according to claim 4, wherein
one first thermal member in the plurality of first thermal members of the second substrate is arranged to face one second thermal member in the plurality of second thermal members of the first substrate in a thickness direction of the state detection sensor;
one second thermal member in the plurality of second thermal members of the second substrate is arranged to face one first thermal member in the plurality of first thermal members of the first substrate in a thickness direction of the state detection sensor;
the first forming material to be filled into the plurality of first through holes in preparing the first substrate and the first forming material to be filled into the plurality of second through holes in preparing the second substrate are the same; and
the second forming material to be filled into the plurality of first through holes in preparing the first substrate and the second forming material to be filled into the plurality of second through holes in preparing the second substrate are the same. 6. The manufacturing method of the state detection sensor according to claim 4. wherein
each of the plurality of first thermal members of the second substrate is provided at a portion facing each of the plurality of second thermal members of the first substrate with respect to a thickness direction of the state detection sensor;
each of the plurality of second thermal members of the second substrate is provided at a portion facing each of the plurality of first thermal members of the first substrate with respect to a thickness direction of the state detection sensor;
the plurality of first thermal members of the first substrate are arranged in line-symmetry with respect to the plurality of second thermal members of the first substrate;
the plurality of first thermal members of the second substrate are arranged in line-symmetry with respect to the plurality of second thermal members of the second substrate;
the first forming material to be filled into the plurality of first through holes in preparing the first substrate and the first firming material to be filled into the plurality of second through holes in preparing the second substrate are the same;
the second forming material to be filled into the plurality of first through holes in preparing the first substrate and the second forming material to be filled into the plurality of second through holes in preparing the second substrate are the same;
preparation of the first substrate includes:
placing a first mask on a surface of the first substrate in which the plurality of first through holes are formed;
making the first through holes open using the first mask, where the plurality of first thermal members are to be formed among the plurality of first through holes;
filling the first forming material into the first through holes in a state where the first through holes where the plurality of second thermal members are to be formed among the plurality of first through holes are closed;
placing a second mask on a surface of the first substrate in which the plurality of first through holes are formed;
making the first through holes close using the second mask, where the plurality of first thermal members are to be formed among the plurality of first through holes; and
filling the second forming material into the first through holes in a state where the first through holes where the plurality of second thermal members are to be formed among the plurality of first through holes are opened, preparation of the second substrate includes:
inverting front and back surfaces of the first mask from when filling; the first forming material in the first substrate;
placing the first mask on the surface of the second substrate in which the plurality of second through holes are formed;
making the second through holes open using the first mask, where the plurality of first thermal members are to be formed among the plurality of second through holes;
filling the first forming material into the plurality of second through holes in a state where the second through holes in which the plurality of second thermal members are to be formed are closed among the plurality of second through holes;
inverting front and back surfaces of the second mask from when filling the second forming material in the first substrate;
placing the second mask on the surface of the second substrate in which the plurality of second through holes are formed;
making the second through holes close using the second mask, where the plurality of first thermal members are to be formed among the plurality of second through holes; and
filling the second forming material into the plurality of second through holes in a state where the second through holes in which the plurality of second thermal members are to be formed are opened among the plurality of second through holes.
